(19) United States
(12) Patent Application Publication
(10) Pub. No.: US 2005/0044079 A1
(43) Pub. Date: Feb. 24, 2005

(54) Visual representation of data within a database

(76) Inventors: Robert F Abineri, Cambridge (GB); Matthew Jackson, Stoke-On-Trent (GB); Terry Shackle, Ipswich (GB)

Correspondence Address: NIXON & VANDERHYE, PC, 1100 N GLEBE ROAD, 8TH FLOOR, ARLINGTON, VA, 22201-4714, US

(21) Appl. No.: 10/494,949

(22) PCT Filed: Nov. 11, 2002
(86) PCT No.: PCT/GB02/05079

(30) Foreign Application Priority Data
Nov. 9, 2001 (EP) 01309483.4

(51) Int. Cl. G06F 17/30; G06F 17/00

(52) U.S. Cl. 707/10; 707/102; 707/104.1

(57) ABSTRACT

A display (27) provides a visual representation of data within a database (20) received via display generator (34). A first part of the display is concerned with a generated tree relating to selected data from the database. A second part of the display is concerned with a generated gauge which is displayed concurrently with the first part of the display and represents a visual indication of the state of the database or the data within the database.

The invention relates to a method and system for visually representing data within a database. The database may be within an inventory network management and planning system.

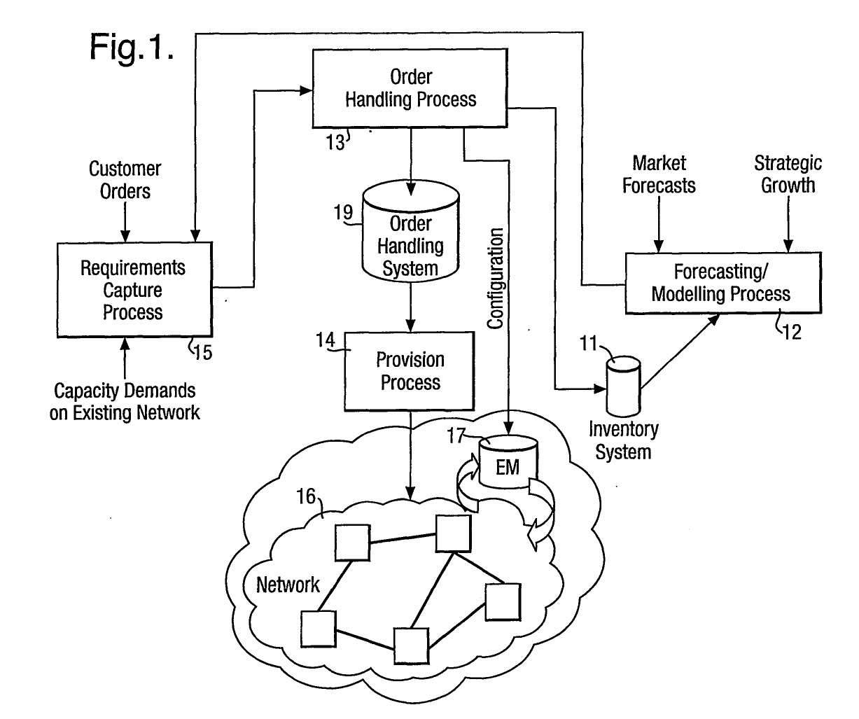

A known basic network management system is shown in FIG. 1 and includes a network inventory database 11, a network forecasting or modelling tool 12 and an order handling arrangement including a handling processor 13 and a handling system 19 with its own data storage. Provisioning 14 is provided following orders raised by handling system 19. Additional network requirements are input to the provisioning system from requirements block 15 providing requirements capture.

The network 16 will have been constructed based on a vendor's configuration, information thereon being held within an element manager block 17 including structure and traffic information. This can be made available to the inventory system.

The inventory database 11 holds information on the existing network 16, which information will have been entered previously, typically manually. The stored information will relate to network sites, switches and shelves, slots or cards relating to those switches as well as port information.

Network management can be dealt with under a management protocol (e.g. SNMP2-simple network management protocol 2).

The network forecasting or modelling tool 12 accesses the data stored in the inventory 11 to allow modelling of the network to be achieved also taking into account market forecasts and strategic growth. The inventory database 11 will also contain information on what physical components of the network are being utilised and this allows the modelling tool to provide an output (e.g. in spreadsheet form) of areas which may have spare capacity.

When new equipment or other provisioning is required these are passed to the provisioning system 14 from requirements process block 15 via order handling process 13 and system 19. New equipment is ordered by manual selection of the appropriate network availability (having considered the availability determined from the output of forecasting system 12).

With such a system, whilst it provides basic network management, it is built around a single vendor's equipment only. Further the inventory data will typically be incomplete and inaccurate due to errors in tying the element manager information to that held in the inventory, to planned changes not yet held in the inventory and inventory data being insufficiently detailed to identify easily and accurately where any spare capacity resides. It has been estimated that the inventory database in such systems can vary from an actual network situation by as much as 50% so leading to inefficient utilisation of the network, with the associated costs involved.

The present invention is concerned with improving this situation.

According to the invention there is provided a method of visually representing data within a database including the steps of generating a display of selected data in the form of a tree and generating an indication gauge concurrently with the tree to represent a visual indication of the state of the database or the data therein.

Further according to the invention there is provided a system for visually representing data within a database including first generator means for generating a display of selected data in the form of a tree and second generator means for generating an indication gauge concurrently with the tree to represent a visual indication of the state of the database or the data therein.

The invention will now be described by way of example with reference to the accompanying drawings in which:

FIG. 1 shows a known example of an inventory system incorporated into a network management system;

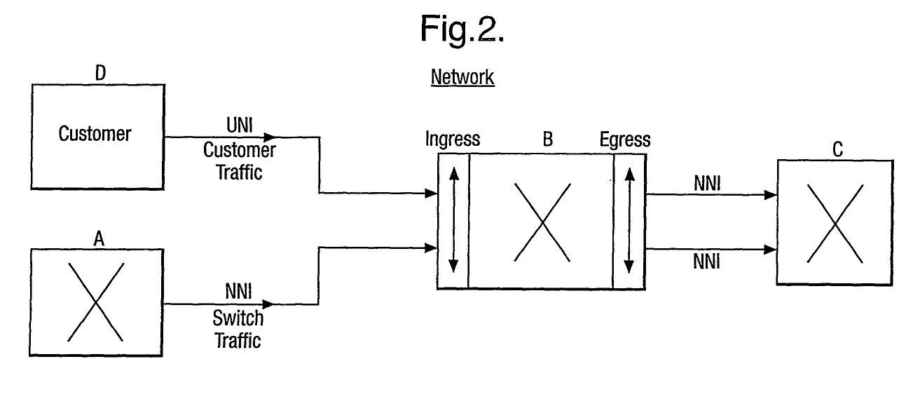

FIG. 2 shows part of the network with customer and switch traffic;

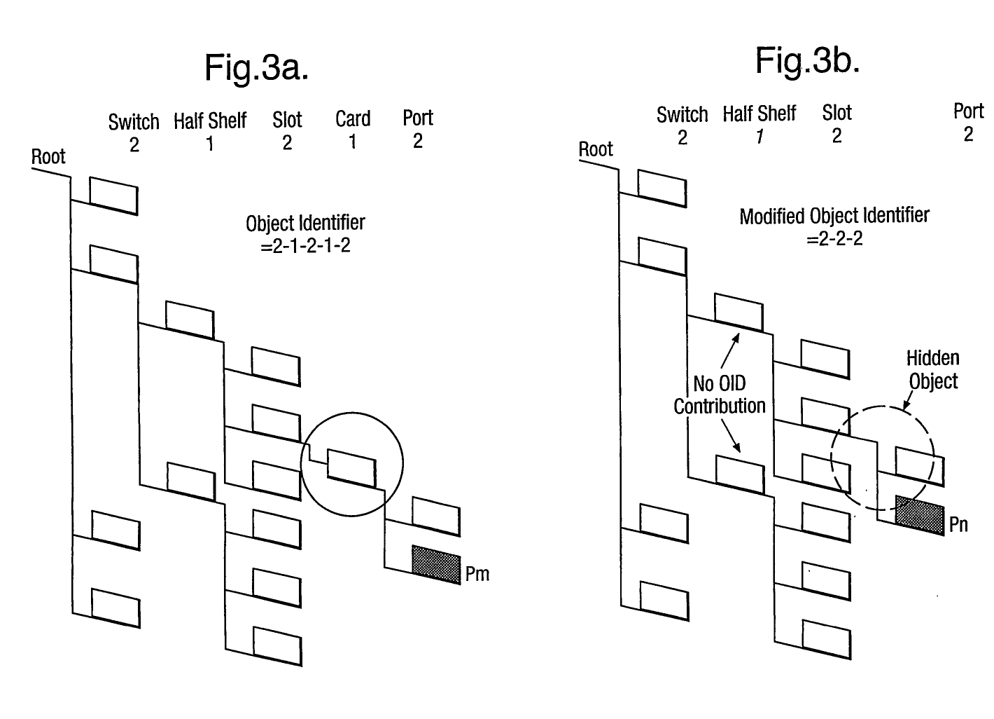

FIGS. 3A and 3B shows network components represented in an object tree;

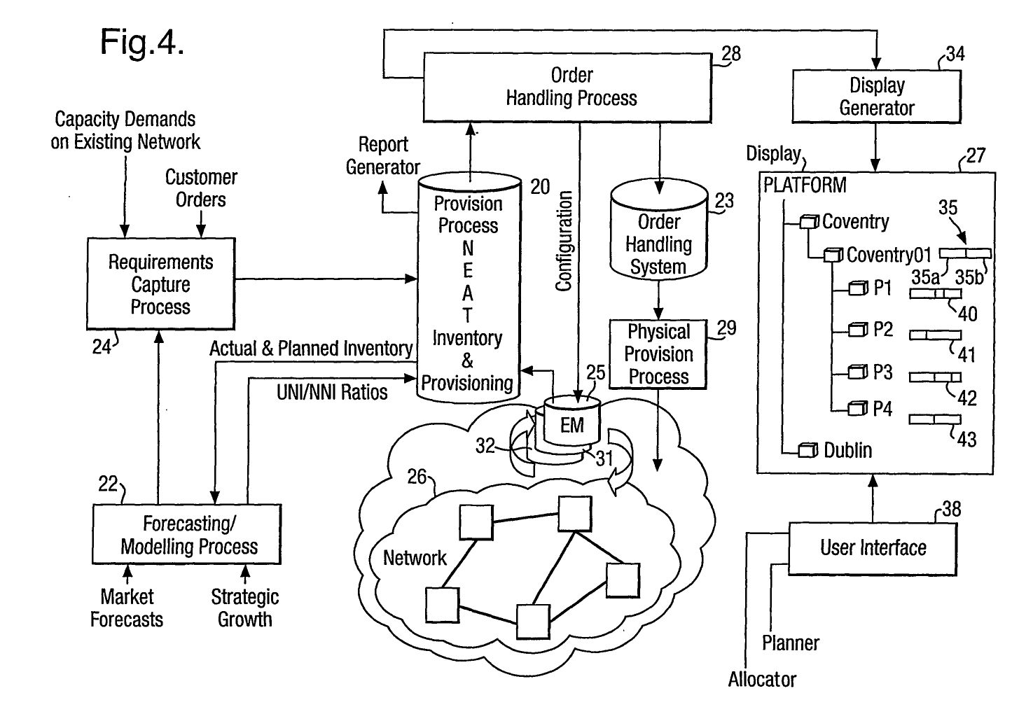

FIG. 4 shows an enhanced network inventory and planning system incorporating the object oriented inventory database with associated devices including a display;

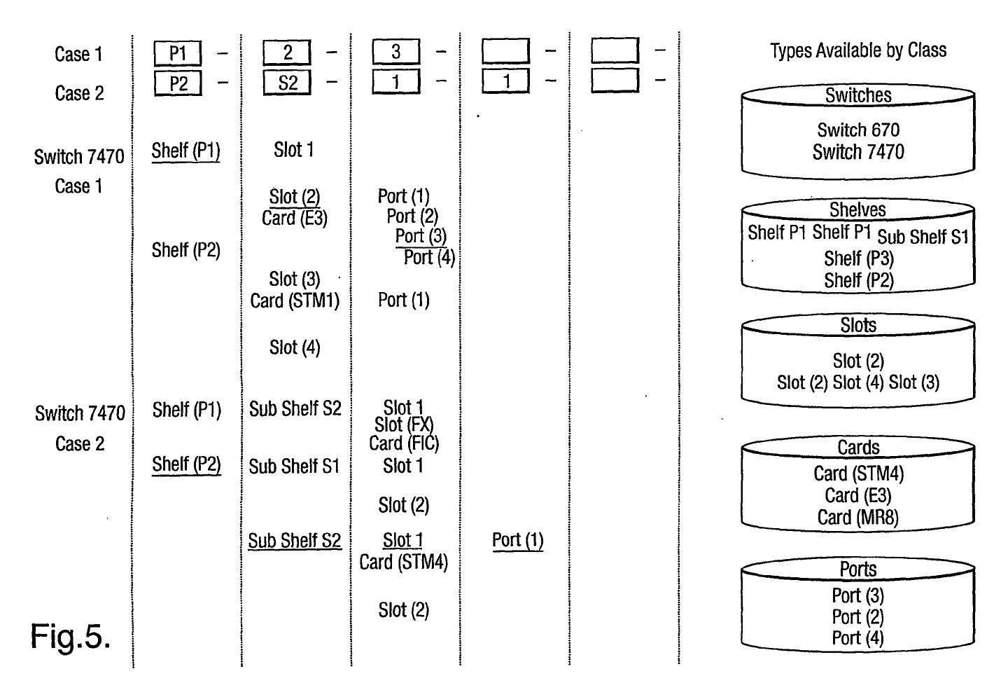

FIG. 5 shows equipment modelling on associated classes;

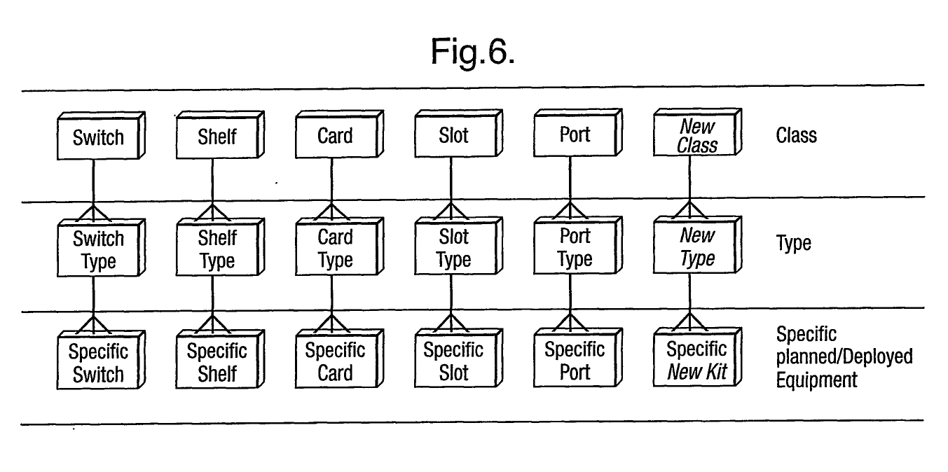

FIG. 6 illustrates component class types;

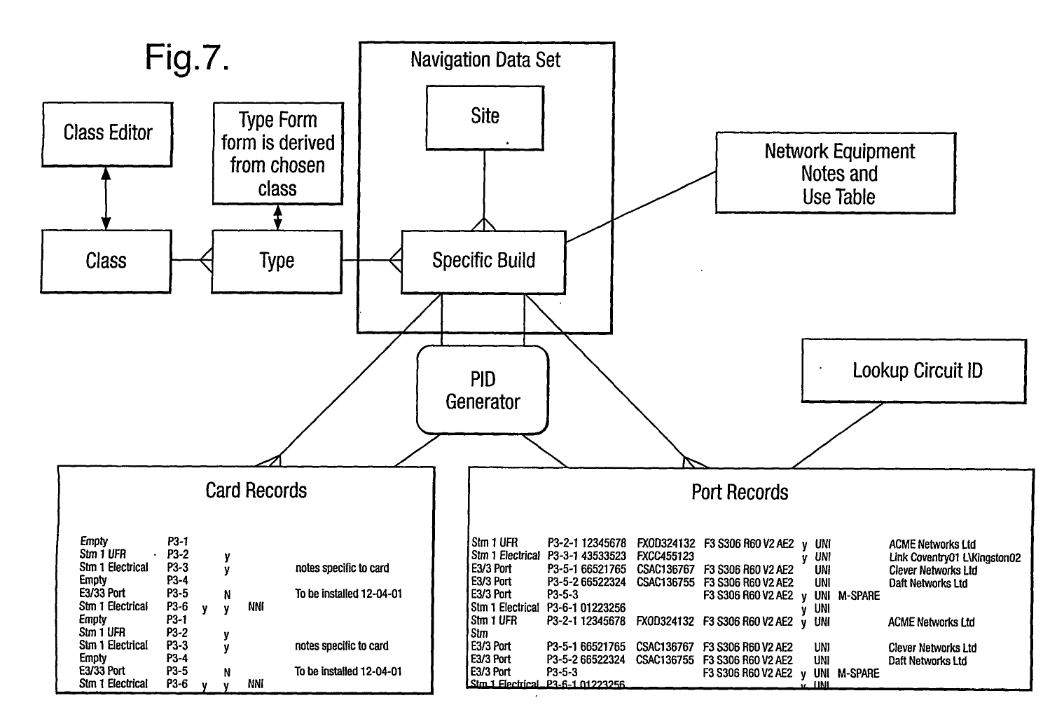

FIG. 7 shows navigation data set mechanisms;

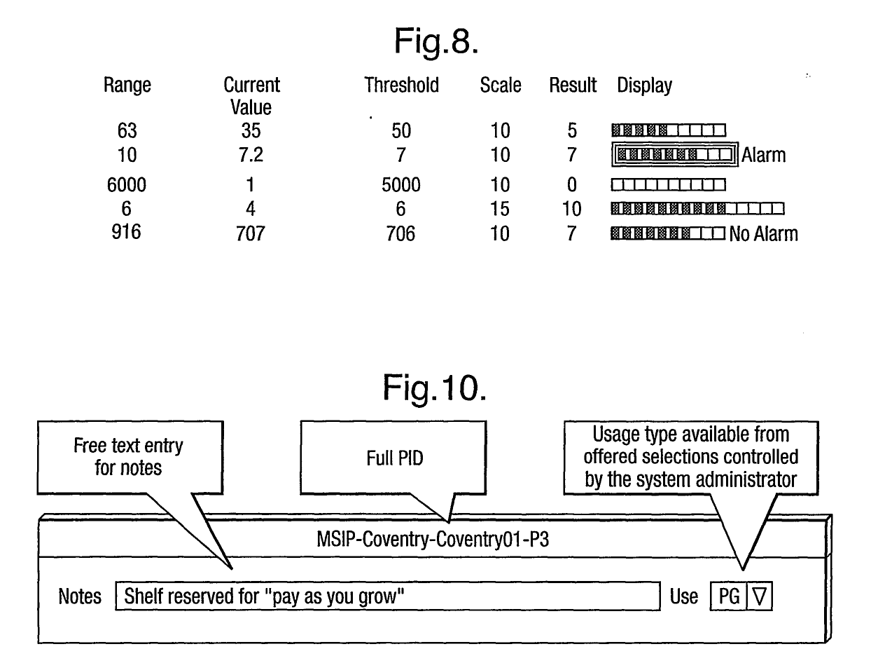

FIG. 8 shows display indicia with associated values;

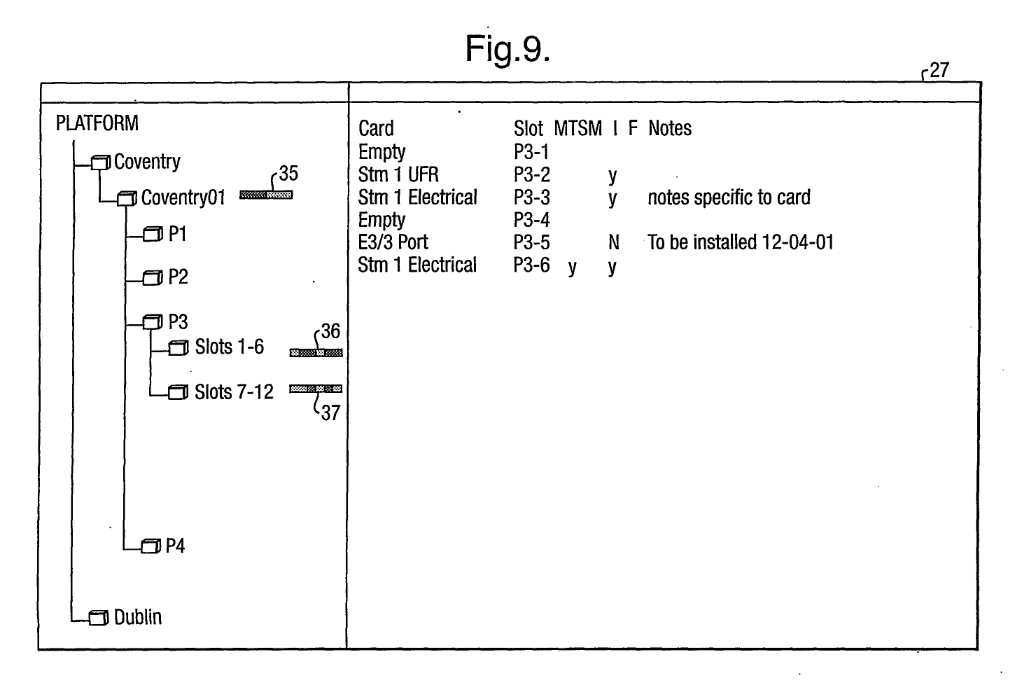

FIG. 9 shows both a tree view and a list view displayed simultaneously;

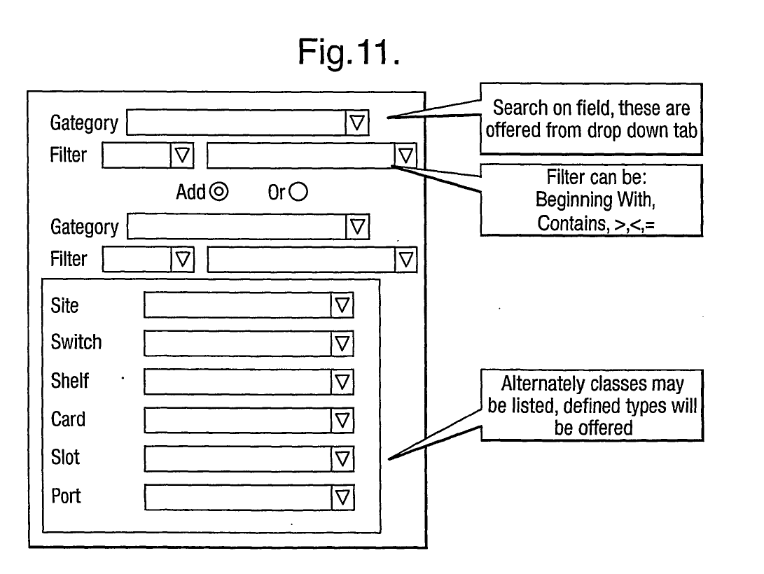

FIG. 10 shows a portion of the graphical display interface to allow entry of usage type values;

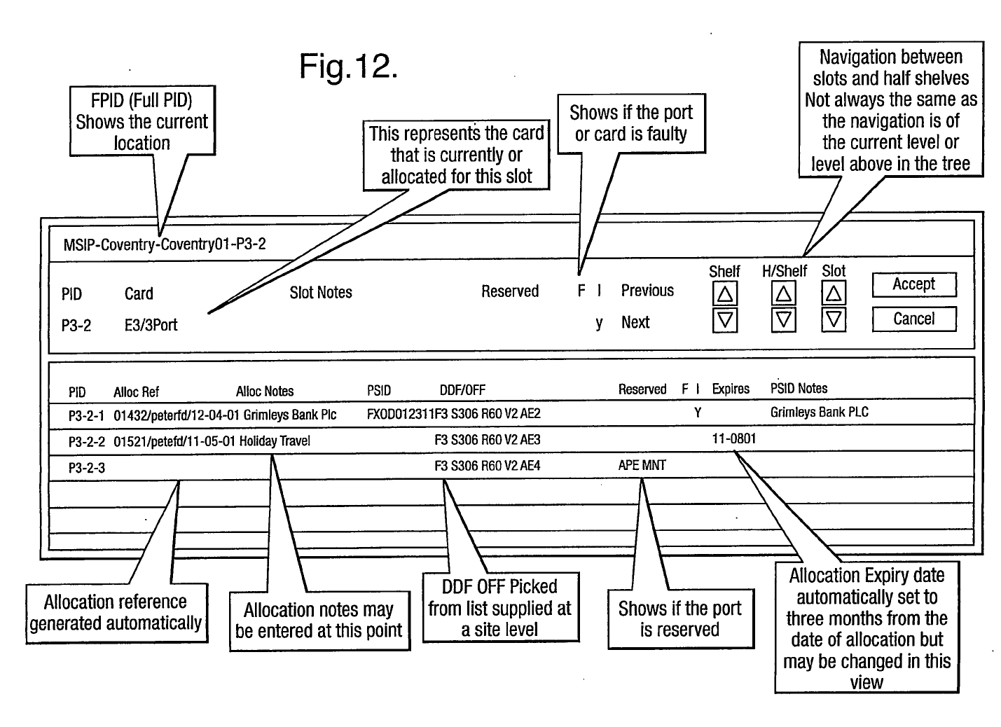

FIG. 11 shows a screen view associated with the search facility;

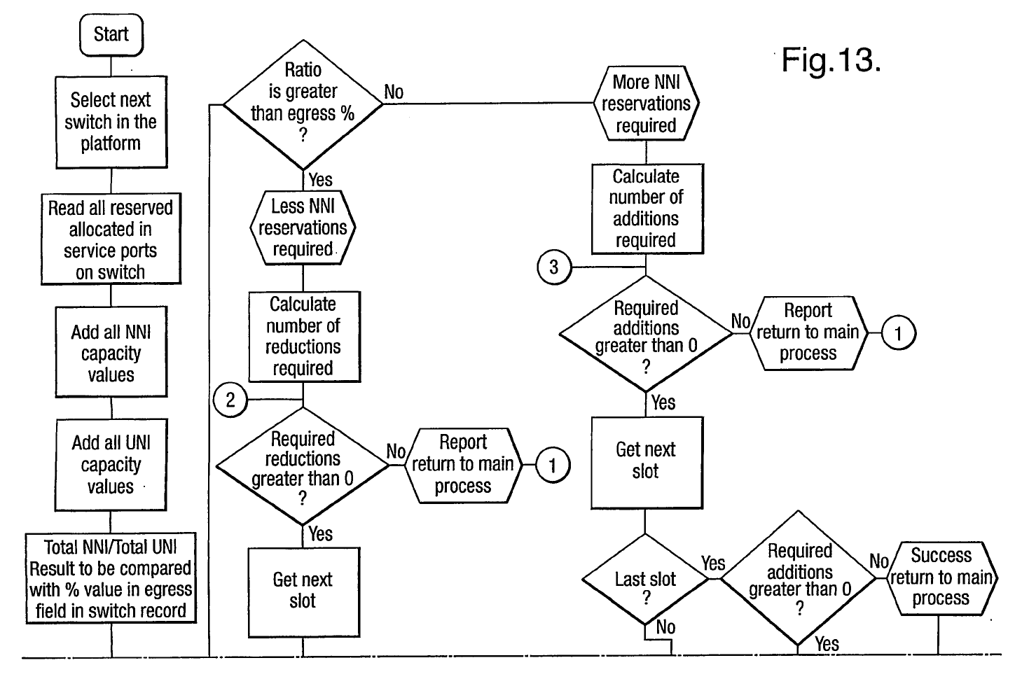

FIG. 12 shows a screen view associated with selection or a slot or port record; and

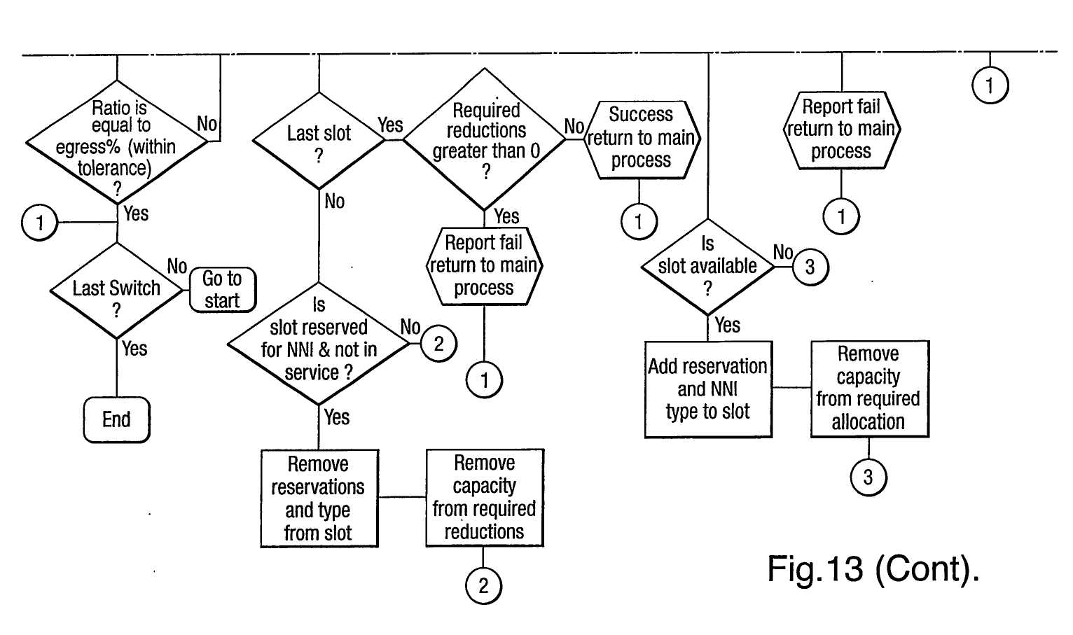

FIG. 13 shows a flowchart concerned with network allocation and reservation.

As discussed above, the FIG. 1 arrangement, whilst providing a basic network management approach, is inflexible, because the inventory database will have been built to accommodate a single vendor's equipment only. In addition, in such a system the file listing would not identify where in a particular switch, for example, the spare capacity was located. The planner therefore would need to take the information and investigate in more detail what allocation ports were appropriate.

Further the planner would need to review switch location positions in the network to ensure traffic requirements were not exceeded for switches or ports on the switches, which switches would typically have to cope with a mixture of network to network interface (NNI) traffic and user to network interface (UNI) traffic.

Still further, as the inventory database is tied to one vendor's equipment, changes to another vendor will require reworking of the whole database, as the identification tags to identify switch type and other criteria, such as number of slots or card types, will be different and not easily accommodated.

Instead of implementing such a basic system, we have devised an enhanced configuration including a sophisticated object oriented database to allow these shortcomings to be overcome using the following approach.

In FIG. 2, a portion of a typical network is shown. The network includes a number of switches A, B, C connected as shown. A customer D has access to the network via switch B. This user traffic or (UNI) ingress has to be accommodated as well as switch traffic (NNI) ingress. The switch B output is entirely NNI traffic to switch C. Hence the egress will be entirely NNI. Therefore, dependent on the position in the network, the database is arranged to incorporate presets on the UNI to NNI ratio, with a default typically 50% and with a traffic maximum (switch fill) preset typically 80%.

Switches, for example will be structured to include shelves, cards and ports and the layers can be represented by the tree structure of FIG. 3A. However, not all switches are constructed identically and, as shown, can include sub-shelves for example which can give rise to errors in the correct identification of ports within the structure when trying to construct an object oriented database where standard object tree rules require that each class of object in the tree adds to the overall object identifier.

Hence port Pm in FIG. 3A will have the object identifier 21212 as its path from the root in FIG. 3A is switch 2, shelf 1, slot 2, card 1, port 2.

However, as we no longer need the identifier to identify the switch (because the index file uses the switch name as the record key) we can modify the object identifier and in this example and port Pn which is the same physical port as Pm would have the modified identifier 222 attributed to it as its path from the root is shelf 2, slot 2, port 2 (see FIG. 3B) for the reasons described below.

The modified identifier, in combination with the switch name (i.e. Coventry) forms the unique key in the other filing system.

Hence our discovery that we can build a modified object tree structure by creating objects which may or may not add to the object identifier allows the identifier to be edited or reordered (e.g. reversed) and by allowing classes to ‘accommodate’ other objects. We have determined that when a path in the tree ends at only one location, then any objects in that path may adopt the attribute of its child and the existence of that object may be removed from the description of the path, so that it is masked or hidden. The object identifier of the class accommodating such an object can identify the ‘hidden’ object.

Hence in the FIG. 3B arrangement, the card at 2121 (previously shown in the FIG. 3A view) can be associated with slot at 212 so that this object (card) is accommodated by the slot (and is now ‘hidden’ in the tree view). This then gives an identifier 2122. Also, the half shelf at 21 does not contribute to the object identifier leaving a modified object identifier of 222.

This computer indexing method adds a virtual dimension to the database so instead of merely referencing up or down the tree, a different path for parallel referencing is introduced, the second object identifier determines the contribution to the tree structure.

Hence in this example the first object identifier is 21212 and the second object identifier is 222. If desired, more than two object identifiers can be utilised to enable multiple index references to be provided.

This mechanism allows us to incorporate the vendor's index as we build the tree and so avoids the need for a separate object identifier and vendor identifier scheme. This also allows a new vendor's equipment to be added to the inventory system by building that vendor's identifiers into the object identifier.

This method of indexing a flat file (i.e. a non object oriented file) to an object orientated database by defining classes and ‘accommodating’ objects provides a powerful tool to provide a more accurate database, so that the network can be more realistically utilised.

As shown in FIG. 4, the system including the network equipment allocation tool (NEAT) which employs an object oriented inventory database 20 for network 26 is built with data received from the vendor's data available from the element manager 25 by employing the modified object tree procedure described above. Other defining data is provided from forecasting/modelling process block 22 to preset UNI/NNI levels and other site information such as switch fill maxima.

The database 20 is now arranged such that the requirements processor 24 is intrinsically linked to the database so that actual inventory data in database 20 is also updated with planned inventory data, even before the additional utilisation is installed, so that the database 20 provides a more current appraisal of the network utilisation than heretofore due to the presence of inventory portions associated with currently provisioned network facilities and with planned network facilities. This in turn allows the forecasting device 22 to provide a more accurate model of network structure and utilisation as it receives actual and planned inventory data from database 20. By providing a single data source for both planned and in use network resources, any planner with access to the system will have all requisite information for further planning.

The inventory 20 now provides network information to the order handling processor 28 to ensure accurate provisioning so as to drive the order handling system 23. This provisioning process utilising the inventory 20 as an output to the order handling process maintains accurate operation and the order handling output from system 19 allows physical provision implementation.

The system can cope with more than one vendor's equipment and element managers 31, 32 also provide information on the network for receipt by the database 20.

A unique display 27 allows utilisation and network structure information held in database 20 to be displayed via generator 34. In the example shown the site information (i.e. Coventry) is represented in tree form to illustrate switch 1 with shelves P1 to P4. The linear indicia bar type display 35 with portions 35a, 35b is configurable to represent capacities (e.g. ingress/egress) and their utilisation on the network. Its generation is described with reference to FIG. 8 below. The darker the shade of the display, the greater the amount of egress already utilised relative to the preset value. If a colour display is provided the linear indicia of the display could change from green to red with intermediate colours when some way beyond minimum towards the maximum. The displays 40 to 43 show availability on shelves P1 to P4 respectively.

In a similar manner FIG. 9 shows the tree view together with the bar display 36 associated with slots 1-6 and display 37 for slots 7-12 on shelf P3 to indicate how many slots are populated. This is an important tool, allowing answers to capacity to be visually provided in a form understandable to non-specialist users and allow a planner to quickly identify a suitable location for a new link. The report generator 30 produces further information such as trend analysis, platform health, planning rule observance and planning listings.

A user interface 38 which may be web-based allows access to planners and allocation administrators with appropriate security mechanisms in place.

To build the database for network inventory or to add to the database will require various steps dependent on the equipment descriptions to be used. So starting with initiating equipment, the steps required are as follows:
1. Define sites
2. Define equipment classes
3. Define equipment types (based on classes)
4. Define specific equipment (based on types).

As mentioned above, the object identifier is a value which represents a unique position in a tree derived from the node positions at each level of the tree. In the present arrangement, however, objects are assigned to a class which cause a described object to behave differently in a tree as follows:
1. The Object identifier contribution for the described object may be switched off.
2. The Object class defines that the described object is able to parent.
3. The Object class defines that the described object is able to accommodate.

As regards accommodation, when an object in a tree has only one child, the child can be accommodated by the parent and the accommodated child can be removed from the tree and the accommodating object adopts the attributes of the accommodated child.

By using the additional rules above, where objects are required in the navigation view and are not used to identify the child object, the contribution to the object identifier can be removed.

Where objects are not required in the navigation view but that object's children are, then that object may be accommodated by its parent object.

Site attributes are stored in a site table (see FIG. 7). This could define the Coventry site referred to in FIG. 4.

The equipment classes are user defined and are used to control the generic relationships between various network equipment object types as described above.

Hence, the class name can specify whether an equipment type can parent or accommodate or whether a port identifier is required.

An example of an equipment class definitions with various attribute possibilities is shown in Table 1.

TABLE 1
Equipment Class Example

| | | May | PID Value |
|---|---|---|---|
| Class | Parent of | accommodate | included |
| Switch | Shelf | Nothing | No |
| Shelf | Shelf Slot | Nothing | Yes |
| Slot | Slot Port | Card | Yes |
| Card | Port Slot | Nothing | No |
| Port | Nothing | Nothing | Yes |

The port identifier (PID) value is not included for either the class switch or card. This is because when created, the PID needs to correspond to the PID from the vendor's report.

Where half shelves are employed, a class for modelling these is required and the attributes shown in Table 2 would be used.

TABLE 2

| Name | Parent | Accommodates | PID |
|---|---|---|---|
| Half Shelf | Slot | Nothing | No |
| The name of the | Half shelves will | Half shelves will | The half shelf |
| class | parent only slots | not contain | should not be |
| | | cards | included in the |
| | | | PID for any |
| | | | card or port |

The port identifier (PID) discussed above is essential in identifying either a port or a slot, the element manager (from the vendor's database) will identify a specific slot or port using the switch name and the PID alone. Hence, for example, P1-2 would locate slot 2 in shelf 1 or P1-5-1 locates port 1 in slot 5 of shelf 1 (see also FIG. 5). Some pieces of network equipment do not add to the PID value (card, for example) and the offsets of the various values of the PID can change depending on the build used. This allows the correct identification of ports or slots to be made.

The relationships between equipment class type, equipment type, site and specific build are shown in FIG. 7.

Having defined all the equipment types required then a switch may be built.

An example of a created switch using the previously defined equipment types will follow the format shown in Table 3.

TABLE 3

| Attribute | Example |
|---|---|
| Site | Any town |
| Class | Switch |
| Type | |
| Name | Any town 01 |
| Alt Name | 01234 |
| Site Code | AT/01 |
| Address | |
| Access Fill % | 80% |
| UNI/NNI Ratio | 50% |
| Floor | G |
| Suite | 6 |
| Rack | 130 |

| | | | | |
|---|---|---|---|---|
| Parent of | | Floor | Suite | Rack |
| | P1 | LG | 12 | 270 |
| | P2 | LG | 12 | 250 |
| | P3 | LG | 12 | 230 |
| | P4 | LG | 12 | 210 |

The values for site, class and type are taken from their definitions. The Name identifies the equipment and appears in the navigation tree. The Alt Name is the five digit number used by the vendor element manager to identify the switch. The preset UNI/NNI ratio and the Access Fill are entered as shown. Floor to Rack is concerned with location of the switch fabric. The columns relate to information chosen from the class shelf. As the switch class is defined as ‘parent of shelf’ then only shelf types will be altered. The Alt Name and Address fields will be empty at the time of creation of the planned switch process. All attributes from this point cascade down the tree to the ports.

As shown in the display of FIG. 4, the navigational view using an object tree approach gives rapid and clear information on the site information and switch build. The mechanisms associated with the navigation data set are shown in FIG. 7.

As discussed above, the inventory is built using object oriented data in the modified tree form unique to the system. The navigation through the network includes network site and the components within that site. Hence, as shown in FIG. 7, the class is created under the control of editor with the three attributes set by the rules and these variable classes are then attributed types. In other words, each type will always be in a class (e.g. slot or card) generic to the network equipment that may be used by an operator. The variable type is selected for the specific build to identify the actual component within the context of their location and use.

NEAT enables the system operators to create a database which can reflect the format of any vendor's element manager output thereby enabling the population and comparison of data within the database with the element manager data. Due to the flexibility of the tree many element manager data formats may be represented thereby allowing NEAT to support multiple equipment makes and types.

Empty slots may be populated with planned data which may be simultaneously available to a number of planners in various locations within an operator's business.

As records may be identified as either ‘in service’ or ‘planned’, then output to other operation, service and support tools (OSS) may include either in service and planned or in service or planned.

For the card records and port records illustrated in FIG. 7 (which represent the flat files or non-object oriented fill-list data from the vendor's element management database) these are indexed by using the port identifier (PID) generator to allow the navigation data set to be built. The data stored can be accompanied by notes to enhance the representation of the system.

Customer circuit ID will be concerned with customer details in the lookup circuit ID.

Hence the graphical representation displayed is the navigational view of the object oriented database in relation to the relevant object, used to represent the state of the database or the data contained within the database and as shown in FIG. 4 includes visual indicia in the form of an indicator or gauge via the display generator.

The indicator will change colour and/or shape to indicate that a threshold set within the range of the gauge has been reached, exceeded or has fallen below the threshold.

At least four values are required which may be either operator defined or derived from values or results of calculations performed on one or more values within the database and may include operator defined data.

The four values required to generate the gauge or indicator are:
RANGE (the extent of the indicator)
VALUE (the current value of the indicator)
THRESHOLD (the value used to trigger a change in the display of the indicator or gauge when the current value either equals, exceeds or does not exceed the THRESHOLD value, the behaviour can be defined by a user) additional THRESHOLDS can be used to activate different animations of the gauge or indicator display (e.g. green, amber, red)
SCALE (the granularity of the indicator).

The resultant display from the example below will be visible to the user in the context of the navigation tree view of FIG. 4, display 27.

### METHOD EXAMPLES

Where Result=INTEGER((CURRENT VALUE/RANGE)*SCALE) Alarm if CURRENT VALUE>=THRESHOLD (Note, in some instances the alarm may be true if CURRENT VALUE<=THRESHOLD).

The display is constructed using the same number of image parts or a multiple of SCALE and some coloured or changed to represent the CURRENT VALUE based on the value in Result.

Examples of typical values and resultant display is shown in FIG. 8.

The displays shown on the right column show a scale with either 10 or 15 segments. The result (using the formula) will, in the first display instance, cause 5 segments to be darkened. Other combinations are illustrated including alarm function.

In addition to the tree view, a list view can be provided to produce a one line record for every instance of the level below the current navigation level. Hence, if the navigational view selected is at shelf level, the list display will show the list of cards.

Hence, in the tree view of FIG. 4, the list view relate to the slots and will be as shown in FIG. 9. Both the tree and list view can be viewed simultaneously on the display, if required. Under mouse control by double-clicking on the screen, the display can show the next level both for tree and list view as appropriate. Hence, selecting the slot information of FIG. 9 will produce port information for display.

The list view can be set to show all ports from the point selected in the navigational tree view and below.

The expansion or collapsing of the views is therefore possible to provide the degree of information required with availability shown in the tree view by the bar display.

Table 4 shows the hierarchy based on the switch used in the example described.

TABLE 4

| | | List View (Selecting |
|---|---|---|
| | | either note or use will |
| | | open notes/use |
| Level | Description | dialog) |
| Platform | This is the root of the | None |
| | tree | |
| Site | This is the name of the | Site code, Notes |
| | site which is taken from | |
| | the Site Details Form | |
| Switch | This is the name of the | Site code, PNNI |
| | switch which is taken | Address, Use Notes |
| | from the specific | |
| | equipment form for the | |
| | switch | |
| Shelf | This will show the PID | Notes Use |
| | value from the specific | |
| | equipment form | |
| Sub Shelf or Slot | On some equipment | Notes Use |
| | there may be a slot or a | |
| | card at this level | |
| Slot | The slot accommodates | Slot list view (see FIG. 9) |
| | Cards and the attributes | |
| | of the card will create | |
| | the lower branches of | |
| | the tree. The PID value | |
| | of the Slot will be | |
| | displayed | |
| Port | This will show the PID | Port list view |
| | value for the slot | |

The Notes/Use dialog will be available to Planner/Builders and Allocation Administrators. As shown in FIG. 10, the usage type value is settable by the system administrator from a selected on-screen display.

Additional screen views allow access to the data within the database.

The graphical user interface (GUI) could be accessible remotely in the network (or web-based) and the database and other components can be constructed using ORACLE system software.

FIG. 11 shows the screen view associated with a comprehensive search facility to enable administrators to search both the card records and the port (Link End) records data, which will be displayed as a list view. The output would also be printed or saved to file in a comma separated variable length text file format (CSV format).

FIG. 12 shows the screen view associated with selection of either a slot record or a port record. Users can edit the port allocation or change the cards in the slot in this view.

As some cards support a number of ports, if a card is changed, the display will generate a warning to the user so that they will be aware of the possibility of losing all port information. Any allocations made will carry identification information regarding user name and allocation date.

Allocations will carry an expiry date and will be preset, typically for a three month period. This allows allocations to be removed automatically if not used by the expiry date to free up network space.

It will also be possible to view links by selecting the circuit ID. As this is the same as both ends of the link, the port details will be listed for both ends. An example of typical link details generated is shown in Table 5. Here the link is between Coventry switch 1 and Kingston switch 2.

TABLE 5
Link Details for FXCC455123

| | | | | | | | | |
|---|---|---|---|---|---|---|---|---|
| | | Alloc-Alloc | | | | | | |
| Card | Port | Notes | Circuit ID | I | F | Type | Reserved | Link Notes |

Platform-Coventry-Coventry01

| | | | | | | | | |
|---|---|---|---|---|---|---|---|---|
| Stm 1 | Electrical | P3-3-1 | 43522 | FXCC455123 | Y | NNI | Link | Coventry01\ |
| | | | | | | | | Kingston02 |

Platform-L\Kingston-1\Kingston02

| | | | | | | | | |
|---|---|---|---|---|---|---|---|---|
| Stm 1 | Electrical | P6-2-1 | 43523 | FXCC455123 | Y | NNI | Link | L\Kingston02 |
| | | | | | | | | Coventry01 |

FIG. 13 shows a flowchart showing the process employed concerned with verifying and, if necessary, adjusting NNI reservations of network switches.

It takes manually updated values from a switch or a value from the forecasting tool. Based on values stored for each switch, it will reserve or remove reservations of capacity on the switch where possible for egress purposes (NNI). This mechanism prevents manual overallocation of access.

Although the inventory system has been described in terms of a telecommunications network environment, the modified tree approach has applications in other databases where flat file information needs to be converted into an object oriented database. Also, as mentioned above, more than one object identifier can be employed in construction of the database.

A non-network inventory could be constructed for use with ISBN publications for example. In this case depending on whether the searcher was looking for content, publisher or media, for example, then different tree representations could be generated using the method described above.

1. A method of visually representing data within a database including the steps of
generating a display of selected data in the form of a tree and
generating an indication gauge concurrently with the tree to represent a visual indication of the state of the database or the data therein.

2. A method as claimed in claim 1, wherein the indication gauge is generated in the form of linear indicia which change status in dependence of the state of the data.

3. A method as claimed in claim 1, wherein the steps include
setting or selecting a range within the current context of the database,
setting or selecting a value within the current context of the database, and
setting or selecting a threshold to trigger a change in status of the display.

4. A method as claimed in claim 3, wherein indicia provide a changeable display which corresponds to the result determined by Integer (current value/range)×scale
where the scale corresponds to the number of incremental steps or is divisible by the number of incremental steps available with the display.

5. A method as claimed in claim 4, wherein the display is configured as a segmented linear scale, the number of segments totalling the scale value.

6. A method as claimed in claim 4, wherein the display is configured in animated form.

7. A method as claimed in claim 1 including storing data within the database as object oriented data.

8. A method as claimed in claim 7 including the steps of
assigning attributes of the classification object which affect their behaviour in relationship to an object tree and an object identifier to allow the objects to be stored on the database in the form of an object oriented database, whereby the data is stored in a modified object tree form to allow the indexing of a non-object oriented file therein and to allow visual representation of the tree.

9. A method as claimed in claim 8 including the steps of:
defining classes concerning objects to be stored derived from the non-object oriented file,
selectively editing the object identifier dependent on the class of object, and
selectively allowing object classes to accommodate other objects.

10. A method as claimed in claim 8 including the steps of:
accessing and viewing stored data in tree form by utilising stored object, identifier and stored class information.

11. A method as claimed in claim 1 including the step of storing usage parameters with the stored data, the indication gauge providing visual indication of the degree of usage concurrently with the tree display.

12. A system for visually representing data within a database including
first generator means for generating a display of selected data in the form of a tree and
second generator means for generating an indication gauge concurrently with the tree to represent a visual indication of the state of the database or the data therein.

13. A system as claimed in claim 12, wherein the second generator means is configured such that the indication gauge is generated in the form of linear indicia which change status in dependence of the state of the data.

14. A system as claimed in claim 12, wherein the generator means include
means for setting or selecting a range within the current context of the database,
means for setting or selecting a value within the current context of the database, and
means for setting or selecting a threshold to trigger a change in status of the display.

15. A system as claimed in claim 14, including indicia to provide a changeable display under the control of the second generator means which corresponds to the result determined by
Integer (current value/range)×scale
where the scale corresponds to the number of incremental steps or is divisible by the number of incremental steps available with the display.

16. A system as claimed in claim 15, wherein the display is configured as a segmented linear scale, the number of segments totalling the scale value.

17. A system as claimed in claim 15, wherein the display is configured in animated form.

18. A system as claimed in claim 12 including database means for object oriented data.

19. A system as claimed in 18 including
means for assigning attributes of the classification object which affect their behaviour in relationship to an object tree and an object identifier to allow the objects to be stored on the database in the form of an object oriented database, whereby the data is stored in a modified object tree form to allow the indexing of a non-object oriented file therein and to allow visual representation of the tree.

20. A system as claimed in claim 19 including
means for defining classes concerning objects to be stored derived from the non-object oriented file,
means for selectively editing the object identifier dependent on the class of object, and
means for selectively allowing object classes to accommodate other objects.

21. A system as claimed in claim 12 including means for generating usage parameters for storing with the stored data, the indication gauge providing visual indication of the degree of usage concurrently with the tree display.
